(19) United States
(12) Patent Application Publication
(10) Pub. No.: US 2022/0377810 A1
(43) Pub. Date: Nov. 24, 2022

(54) PERFORMING A LISTEN-BEFORE-TALK ON BEAMS AND/OR PANELS

(71) Applicant: Lenovo (Singapore) Pte. Ltd., New Tech Park (SG)

(72) Inventors: Ankit Bhamri, Rödermark (DE); Ali Ramadan Ali, Kraiburg am Inn (DE); Alexander Johann Maria Golitschek Edler von Elbwart, Darmstadt (DE); Karthikeyan Ganesan, Kronberg im Taunus (DE); Joachim Loehr, Wiesbaden (DE)

(21) Appl. No.: 17/759,566

(22) PCT Filed: Jan. 29, 2021
(86) PCT No.: PCT/IB2021/050693

§ 371 Date: Jul. 27, 2022

Related U.S. Application Data
(60) Provisional application No. 62/967,269, filed on Jan. 29, 2020.

(51) Int. Cl. H04W 74/08; H04W 72/04

(52) U.S. Cl. CPC H04W 74/0841; H04W 74/0866; H04W 72/046

(57) ABSTRACT

Apparatuses, methods, and systems are disclosed for performing a listen-before-talk on beams and/or panels. One method (500) includes receiving (502), at a user equipment, at least one indication to use a set of beams, a set of panels, or a combination thereof. The method (500) includes performing (504) the listen-before-talk on at least one beam of the set of beams, at least one panel of the set of panels, or a combination thereof before beginning a downlink reception, an uplink transmission, or a combination thereof. The method (500) includes performing (506) the downlink reception, the uplink transmission, or the combination thereof in response to the listen-before-talk being successful on the at least one beam of the set of beams, the at least one panel of the set of panels, or the combination thereof.

### CROSS-REFERENCE TO RELATED APPLICATIONS

This application claims priority to U.S. Patent Application Ser. No. 62/967,269 entitled “APPARATUSES, METHODS, AND SYSTEMS FOR FAST DIRECTIONAL LBT AT UE IN CONNECTED MODE” and filed on Jan. 29, 2020 for Ankit Bhamri, which is incorporated herein by reference in its entirety.

### FIELD

The subject matter disclosed herein relates generally to wireless communications and more particularly relates to performing a listen-before-talk on beams and/or panels.

### BACKGROUND

The following abbreviations are herewith defined, at least some of which are referred to within the following description: Third Generation Partnership Project (“3GPP”), 5th Generation (“5G”), QoS for NR V2X Communication (“5QI/PQI”), Authentication, Authorization, and Accounting (“AAA”), Positive-Acknowledgment (“ACK”), Application Function (“AF”), Authentication and Key Agreement (“AKA”), Aggregation Level (“AL”), Access and Mobility Management Function (“AMF”), Angle of Arrival (“AoA”), Angle of Departure (“AoD”), Access Point (“AP”), Application Server (“AS”), Application Service Provider (“ASP”), Autonomous Uplink (“AUL”), Authentication Server Function (“AUSF”), Authentication Token (“AUTN”), Background Data (“BD”), Background Data Transfer (“BDT”), Beam Failure Detection (“BFD”), Beam Failure Recovery (“BFR”), Binary Phase Shift Keying (“BPSK”), Base Station (“BS”), Buffer Status Report (“BSR”), Bandwidth (“BW”), Bandwidth Part (“BWP”), Cell RNTI (“C-RNTI”), Carrier Aggregation (“CA”), Channel Access Priority Class (“CAPC”), Contention-Based Random Access (“CBRA”), Clear Channel Assessment (“CCA”), Common Control Channel (“CCCH”), Control Channel Element (“CCE”), Cyclic Delay Diversity (“CDD”), Code Division Multiple Access (“CDMA”), Control Element (“CE”), Contention-Free Random Access (“CFRA”), Configured Grant (“CG”), Closed-Loop (“CL”), Core Network (“CN”), Coordinated Multipoint (“CoMP”), Channel Occupancy Time (“COT”), Cyclic Prefix (“CP”), Cyclical Redundancy Check (“CRC”), Channel State Information (“CSI”), Channel State Information-Reference Signal (“CSI-RS”), Common Search Space (“CSS”), Control Resource Set (“CORESET”), Contention Window Size (“CWS”), Discrete Fourier Transform Spread (“DFTS”), Downlink Control Information (“DCI”), Downlink Feedback Information (“DFI”), Dynamic Grant (“DG”), Downlink (“DL”), Demodulation Reference Signal (“DMRS”), Data Network Name (“DNN”), Data Radio Bearer (“DRB”), Discontinuous Reception (“DRX”), Dedicated Short-Range Communications (“DSRC”), Downlink Pilot Time Slot (“DwPTS”), Enhanced Clear Channel Assessment (“eCCA”), Enhanced Mobile Broadband (“eMBB”), Evolved Node B (“eNB”), Extensible Authentication Protocol (“EAP”), Effective Isotropic Radiated Power (“EIRP”), European Telecommunications Standards Institute (“ETSI”), Frame Based Equipment (“FBE”), Frequency Division Duplex (“FDD”), Frequency Division Multiplexing (“FDM”), Frequency Division Multiple Access (“FDMA”), Frequency Division Orthogonal Cover Code (“FD-OCC”), Frequency Range 1—sub 6 GHz frequency bands and/or 410 MHz to 7125 MHz (“FR1”), Frequency Range 2-24.25 GHz to 52.6 GHz (“FR2”), Universal Geographical Area Description (“GAD”), Guaranteed Bit Rate (“GBR”), Group Leader (“GL”), 5G Node B or Next Generation Node B (“gNB”), Global Navigation Satellite System (“GNSS”), General Packet Radio Services (“GPRS”), Guard Period (“GP”), Global Positioning System (“GPS”), General Public Subscription Identifier (“GPSI”), Global System for Mobile Communications (“GSM”), Globally Unique Temporary UE Identifier (“GUTI”), Home AMF (“hAMF”), Hybrid Automatic Repeat Request (“HARQ”), Home Location Register (“HLR”), Handover (“HO”), Home PLMN (“HPLMN”), Home Subscriber Server (“HSS”), Hash Expected Response (“HXRES”), Identity or Identifier (“ID”), Information Element (“IE”), Industrial Internet-of-Things (“IIoT”), International Mobile Equipment Identity (“IMEI”), International Mobile Subscriber Identity (“IMSI”), International Mobile Telecommunications (“IMT”), Internet-of-Things (“IoT”), Key Management Function (“KMF”), Layer 1 (“L1”), Layer 2 (“L2”), Layer 3 (“L3”), Licensed Assisted Access (“LAA”), Local Area Data Network (“LADN”), Local Area Network (“LAN”), Load Based Equipment (“LBE”), Listen-Before-Talk (“LBT”), Logical Channel (“LCH”), Logical Channel Group (“LCG”), Logical Channel Prioritization (“LCP”), Log-Likelihood Ratio (“LLR”), Long Term Evolution (“LTE”), Multiple Access (“MA”), Medium Access Control (“MAC”), Multimedia Broadcast Multicast Services (“MBMS”), Maximum Bit Rate (“MBR”), Minimum Communication Range (“MCR”), Modulation Coding Scheme (“MCS”), Master Information Block (“MIB”), Multimedia Internet Keying (“MIKEY”), Multiple Input Multiple Output (“MIMO”), Mobility Management (“MM”), Mobility Management Entity (“MME”), Mobile Network Operator (“MNO”), Mobile Originated (“MO”), massive MTC (“mMTC”), Maximum Power Reduction (“MPR”), Machine Type Communication (“MTC”), Multiple Transmission and Reception Point (“M-TRP”), Multi User Shared Access (“MUSA”), Non Access Stratum (“NAS”), Narrowband (“NB”), Negative-Acknowledgment (“NACK”) or (“NAK”), New Data Indicator (“NDI”), Network Entity (“NE”), Network Exposure Function (“NEF”), Network Function (“NF”), Next Generation (“NG”), NG 5G S-TMSI (“NG-5G-S-TMSI”), Non-Orthogonal Multiple Access (“NOMA”), New Radio (“NR”), NR Unlicensed (“NR-U”), Network Repository Function (“NRF”), Network Scheduled Mode (“NS Mode”) (e.g., network scheduled mode of V2X communication resource allocation—Mode-1 in NR V2X and Mode-3 in LTE V2X), Network Slice Instance (“NSI”), Network Slice Selection Assistance Information (“NSSAI”), Network Slice Selection Function (“NSSF”), Network Slice Selection Policy (“NSSP”), Operation, Administration, and Maintenance System or Operation and Maintenance Center (“OAM”), Orthogonal Frequency Division Multiplexing (“OFDM”), Orthogonal Frequency Division Multiple Access (“OFDMA”), Open-Loop (“OL”), Other System Information (“OSI”), Power Angular Spectrum (“PAS”), Physical Broadcast Channel (“PBCH”), Power Control (“PC”), UE to UE interface (“PC5”), Policy and Charging Control (“PCC”), Primary Cell (“PCell”), Policy Control Function (“PCF”), Physical Cell Identity (“PCI”), Physical Downlink Control Channel (“PDCCH”), Packet Data Convergence Protocol (“PDCP”), Packet Data Network Gateway (“PGW”), Physical Downlink Shared Channel (“PDSCH”), Pattern Division Multiple Access (“PDMA”), Packet Data Unit (“PDU”), Physical Hybrid ARQ Indicator Channel (“PHICH”), Power Headroom (“PH”), Power Headroom Report (“PHR”), Physical Layer (“PHY”), Public Land Mobile Network (“PLMN”), PC5 QoS Class Identifier (“PQI”), Physical Random Access Channel (“PRACH”), Physical Resource Block (“PRB”), Proximity Services (“ProSe”), Positioning Reference Signal (“PRS”), Physical Sidelink Control Channel (“PSCCH”), Primary Secondary Cell (“PSCell”), Physical Sidelink Feedback Control Channel (“PSFCH”), Physical Uplink Control Channel (“PUCCH”), Physical Uplink Shared Channel (“PUSCH”), QoS Class Identifier (“QCI”), Quasi Co-Located (“QCL”), Quality of Service (“QoS”), Quadrature Phase Shift Keying (“QPSK”), Registration Area (“RA”), RA RNTI (“RA-RNTI”), Radio Access Network (“RAN”), Random (“RAND”), Radio Access Technology (“RAT”), Serving RAT (“RAT-1”) (serving with respect to Uu), Other RAT (“RAT-2”) (non-serving with respect to Uu), Random Access Procedure (“RACH”), Random Access Preamble Identifier (“RAPID”), Random Access Response (“RAR”), Resource Block Assignment (“RBA”), Resource Element Group (“REG”), Radio Link Control (“RLC”), RLC Acknowledged Mode (“RLC-AM”), RLC Unacknowledged Mode/Transparent Mode (“RLC-UM/TM”), Radio Link Failure (“RLF”), Radio Link Monitoring (“RLM”), Radio Network Temporary Identifier (“RNTI”), Reference Signal (“RS”), Remaining Minimum System Information (“RMSI”), Radio Resource Control (“RRC”), Radio Resource Management (“RRM”), Resource Spread Multiple Access (“RSMA”), Reference Signal Received Power (“RSRP”), Received Signal Strength Indicator (“RSSI”), Round Trip Time (“RTT”), Receive (“RX”), Sparse Code Multiple Access (“SCMA”), Scheduling Request (“SR”), Sounding Reference Signal (“SRS”), Single Carrier Frequency Division Multiple Access (“SC-FDMA”), Secondary Cell (“SCell”), Secondary Cell Group (“SCG”), Shared Channel (“SCH”), Sidelink Control Information (“SCI”), Sub-carrier Spacing (“SCS”), Space Division Multiplexing (“SDM”), Service Data Unit (“SDU”), Security Anchor Function (“SEAF”), Sidelink Feedback Content Information (“SFCI”), Serving Gateway (“SGW”), System Information Block (“SIB”), SystemInformationBlockType1 (“SIB1”), SystemInformationBlockType2 (“SIB2”), Subscriber Identity/Identification Module (“SIM”), Signal-to-Interference-Plus-Noise Ratio (“SINR”), Sidelink (“SL”), Service Level Agreement (“SLA”), Sidelink Synchronization Signals (“SLSS”), Session Management (“SM”), Session Management Function (“SMF”), Special Cell (“SpCell”), Semi-Persistent Scheduling (“SPS”), Single Network Slice Selection Assistance Information (“S-NSSAI”), Scheduling Request (“SR”), Signaling Radio Bearer (“SRB”), Shortened TMSI (“S-TMSI”), Shortened TTI (“sTTI”), Synchronization Signal (“SS”), Sidelink CSI RS (“S-CSI RS”), Sidelink PRS (“S-PRS”), Sidelink SSB (“S-SSB”), Synchronization Signal Block (“SSB”), Subscription Concealed Identifier (“SUCI”), Scheduling User Equipment (“SUE”), Supplementary Uplink (“SUL”), Subscriber Permanent Identifier (“SUPI”), Tracking Area (“TA”), TA Identifier (“TAI”), TA Update (“TAU”), Timing Alignment Timer (“TAT”), Transport Block (“TB”), Transport Block Size (“TBS”), Transmission Configuration Indicator (“TCI”), Time-Division Duplex (“TDD”), Time Division Multiplex (“TDM”), Time Division Orthogonal Cover Code (“TD-OCC”), Time Domain Resource Allocation (“TDRA”), Temporary Mobile Subscriber Identity (“TMSI”), Time of Flight (“ToF”), Transmission Power Control (“TPC”), Transmission Reception Point (“TRP”), Transmission Time Interval (“TTI”), Transmit (“TX”), Uplink Control Information (“UCI”), Unified Data Management Function (“UDM”), Unified Data Repository (“UDR”), User Entity/Equipment (Mobile Terminal) (“UE”) (e.g., a V2X UE), UE Autonomous Mode (UE autonomous selection of V2X communication resource—e.g., Mode-2 in NR V2X and Mode-4 in LTE V2X. UE autonomous selection may or may not be based on a resource sensing operation), Uplink (“UL”), UL SCH (“UL-SCH”), Universal Mobile Telecommunications System (“UMTS”), User Plane (“UP”), UP Function (“UPF”), Uplink Pilot Time Slot (“UpPTS”), Ultra-reliability and Low-latency Communications (“URLLC”), UE Route Selection Policy (“URSP”), Vehicle-to-Vehicle (“V2V”), Vehicle-to-Anything (“V2X”), V2X UE (e.g., a UE capable of vehicular communication using 3GPP protocols), Visiting AMF (“vAMF”), V2X Encryption Key (“VEK”), V2X Group Key (“VGK”), V2X MIKEY Key (“VMK”), Visiting NSSF (“vNSSF”), Visiting PLMN (“VPLMN”), V2X Traffic Key (“VTK”), Wide Area Network (“WAN”), and Worldwide Interoperability for Microwave Access (“WiMAX”).

In certain wireless communications networks, LBT may be used.

### BRIEF SUMMARY

Methods for performing a listen-before-talk on beams and/or panels are disclosed. Apparatuses and systems also perform the functions of the methods. One embodiment of a method includes receiving, at a user equipment, at least one indication to use a set of beams, a set of panels, or a combination thereof. In some embodiments, the method includes performing the listen-before-talk on at least one beam of the set of beams, at least one panel of the set of panels, or a combination thereof before beginning a downlink reception, an uplink transmission, or a combination thereof. In various embodiments, the method includes performing the downlink reception, the uplink transmission, or the combination thereof in response to the listen-before-talk being successful on the at least one beam of the set of beams, the at least one panel of the set of panels, or the combination thereof.

One apparatus for performing a listen-before-talk on beams and/or panels includes a user equipment. The apparatus further includes a receiver that receives at least one indication to use a set of beams, a set of panels, or a combination thereof. In various embodiments, the apparatus includes a processor that: performs the listen-before-talk on at least one beam of the set of beams, at least one panel of the set of panels, or a combination thereof before beginning a downlink reception, an uplink transmission, or a combination thereof; and performs the downlink reception, the uplink transmission, or the combination thereof in response to the listen-before-talk being successful on the at least one beam of the set of beams, the at least one panel of the set of panels, or the combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing a listen-before-talk on beams and/or panels;

FIG. 2 is a schematic block diagram illustrating one embodiment of an apparatus that may be used for performing a listen-before-talk on beams and/or panels;

FIG. 3 is a schematic block diagram illustrating another embodiment of an apparatus that may be used for performing a listen-before-talk on beams and/or panels;

FIG. 4 is a diagram illustrating one embodiment of a system used for various embodiments described herein; and

FIG. 5 is a flow chart diagram illustrating one embodiment of a method for performing a listen-before-talk on beams and/or panels.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes to be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

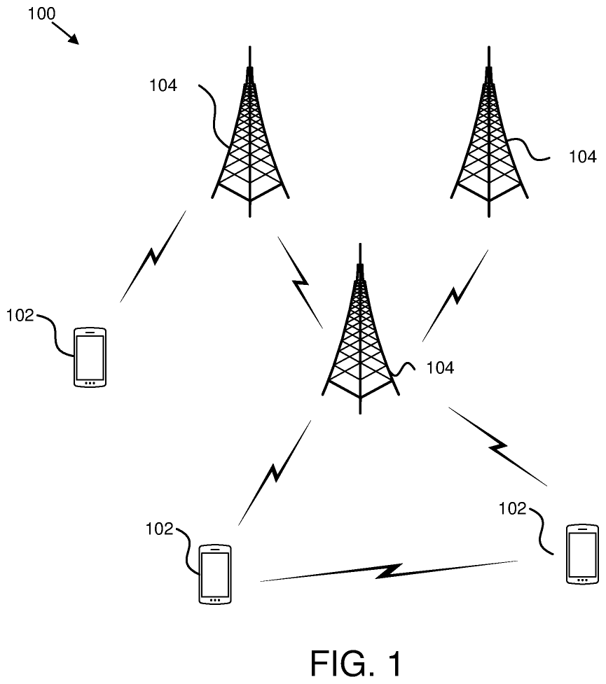

FIG. 1 depicts an embodiment of a wireless communication system 100 for performing a listen-before-talk on beams and/or panels. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an AMF, a UDM, a UDR, a UDM/UDR, a PCF, a RAN, an NSSF, an AS, an NEF, a key management server, a KMF, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may receive at least one indication to use a set of beams, a set of panels, or a combination thereof. In some embodiments, the remote unit 102 and/or the network unit 104 may perform the listen-before-talk on at least one beam of the set of beams, at least one panel of the set of panels, or a combination thereof before beginning a downlink reception, an uplink transmission, or a combination thereof. In various embodiments, the remote unit 102 and/or the network unit 104 may perform the downlink reception, the uplink transmission, or the combination thereof in response to the listen-before-talk being successful on the at least one beam of the set of beams, the at least one panel of the set of panels, or the combination thereof. Accordingly, the remote unit 102 and/or the network unit 104 may be used for performing a listen-before-talk on beams and/or panels.

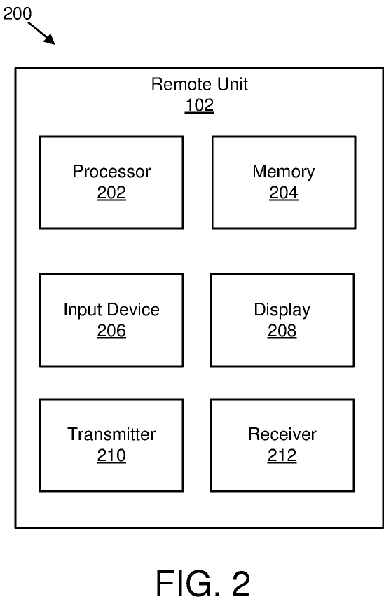

FIG. 2 depicts one embodiment of an apparatus 200 that may be used for performing a listen-before-talk on beams and/or panels. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The receiver 212 may receive at least one indication to use a set of beams, a set of panels, or a combination thereof. In various embodiments, the processor 202 may: perform the listen-before-talk on at least one beam of the set of beams, at least one panel of the set of panels, or a combination thereof before beginning a downlink reception, an uplink transmission, or a combination thereof; and perform the downlink reception, the uplink transmission, or the combination thereof in response to the listen-before-talk being successful on the at least one beam of the set of beams, the at least one panel of the set of panels, or the combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

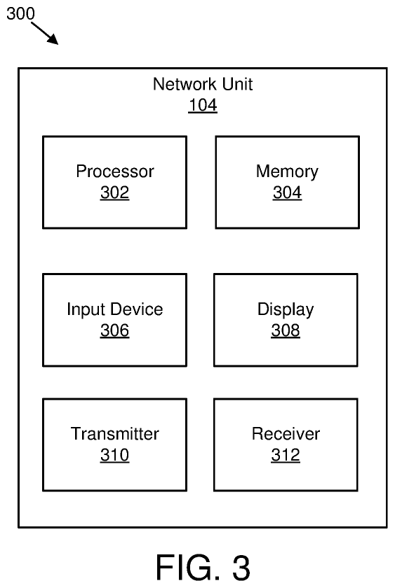

FIG. 3 depicts one embodiment of an apparatus 300 that may be used for performing a listen-before-talk on beams and/or panels. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 may receive at least one indication to use a set of beams, a set of panels, or a combination thereof. In various embodiments, the processor 302 may: perform the listen-before-talk on at least one beam of the set of beams, at least one panel of the set of panels, or a combination thereof before beginning a downlink reception, an uplink transmission, or a combination thereof; and perform the downlink reception, the uplink transmission, or the combination thereof in response to the listen-before-talk being successful on the at least one beam of the set of beams, the at least one panel of the set of panels, or the combination thereof.

In certain embodiments, there may be a channel access mechanism in an unlicensed band for a high frequency range (e.g., FR2), for example. In some embodiments, beam-based operation may be used for an unlicensed spectrum in FR2 and other frequencies. In such embodiments, LBT may be performed in specific beam directions rather than via omni-directional LBT. In various embodiments, LBT at a UE side in connected mode may enable faster channel access by using beam and/or panel based LBT at the UE in the connected state. In certain embodiments, if there is an LBT failure at a UE in a specific panel and/or beam direction, the UE may autonomously switch from one panel and/or beam from the indicated set to another panel and/or beam from the indicated set for performing faster LBT. In some embodiments, parallel LBT may use multiple panels at the same time. In various embodiments, downlink control signaling may be enhanced for facilitating multi-panel and/or beam based LBT at a UE.

In some embodiments, a UE may be configured and/or indicated to by a network to perform LBT before transmission of an UL burst in a connected mode across a set of beams and/or panels. In such embodiments, upon successful LBT on one or more beams and/or panels within the set of beams and/or panels, the UE may start transmitting an UL burst on at least one of the beams and/or panels corresponding to the beams and/or panels with the successful LBT. Moreover, in such embodiments, the UE may not be required to indicate to a gNB about an LBT success and UL transmission on specific beams and/or panels within the configured and/or indicated set.

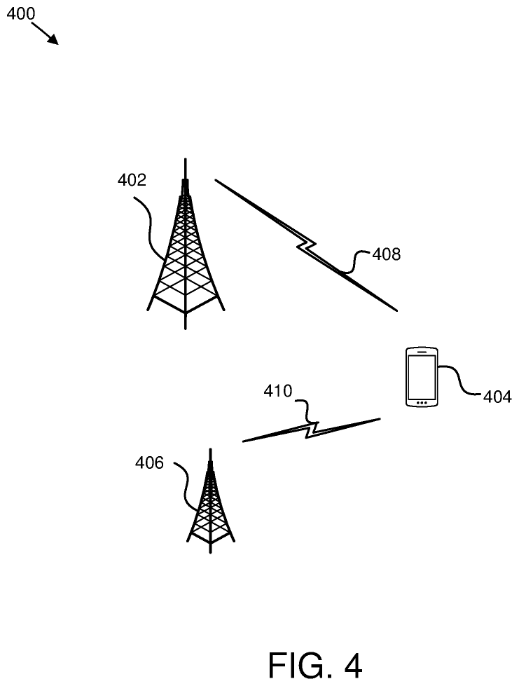

FIG. 4 is a diagram illustrating one embodiment of a system 400 used for various embodiments described herein. The system 400 includes a gNB 402, a UE 404, and an AP 406. Communications 408 may occur between the gNB 402 and the UE 404, and communications 410 may occur between the UE 404 and the AP 406. In one embodiment, the gNB 402 and the UE 404 may both have beams 1-3. The UE 404 may be configured by a network to do LBT on beams 1-3 (corresponding to DL beams 1-3 from the gNB 402). If LBT is carried out by energy detection, beams 2-3 may be idle (e.g., have successful LBT). Accordingly, the UE 404 may choose to perform an UL transmission on the beam corresponding to beam 2 because it is expected to provide the best performance. In some embodiments, the UE may communicate with the AP on both beams 2-3. In some embodiments, the UE 404 may communicate with the AP on beam 1.

As may be appreciated, various embodiments described herein may facilitate increased possibility of succeeding at least one LBT process for an UL transmission by exploiting the spatial dimension for LBT and a reduced latency for starting with a transmission of an UL burst as it is not required to indicate to a gNB about specific beams and/or panels within a set for which LBT is successful. It is expected that the gNB is able to receive the UL transmission from any of the indicated beams.

In certain embodiments, a UE performs LBT on a set of panels and/or beams (e.g., indicated by a gNB) in a time domain manner and if the LBT is successful on a given panel at a certain point of time, then no further LBT is done on any remaining panels and/or beams within the set of panels and/or beams. In such embodiments, upon a first LBT success on one of the panels and/or beams, the UE starts transmitting a scheduled and/or configured UL burst without informing the gNB about the specific panel and/or beams used for UL transmission within the corresponding set. Moreover, in such embodiments, the UL grant in DCI does not indicate a specific panel and/or beam to be used by the UE for UL transmissions. In some embodiments, the UL grant may indicate a set of panels and/or beams. In various embodiments, a set of panels and/or beams may be conveyed to the UE by a previous configuration. In one embodiment, a panel and/or beam may be randomly selected. In another embodiment, a panel and/or beam with a lowest energy detection may be used for transmission. In some embodiments, if multiple panels and/or beams have a lowest energy detection, then the panel and/or beam with a lowest ID may be used for transmission. In certain embodiments, out of beams and/or panels with successful LBT, the panel and/or beam with the strongest corresponding DL reception beam may be selected for transmission. In various embodiments, one or more embodiments described herein for selecting a panel and/or beam for transmission may be combined together.

In some embodiments, if LBT is not successful on a given panel and/or beam, then a UE switches to another remaining configured or active panel and/or beam (if any) and performs LBT on such panel and/or beam. In certain embodiments, if LBT is not successful using any of the configured or active panels and/or beams, a UE may consider LBT as having failed.

In various embodiments, a UE performs LBT on one or more active BWPs of a set of panels and/or beams (e.g., indicated by a gNB) in a time domain manner. First, the UE performs LBT in one or more active BWPs with a certain panel and/or beam and if the LBT is successful on an active BWP with a certain panel and/or beam at a certain point of time, then no further LBT is done on any remaining BWPs for any remaining panels and/or beams within the set of panels and/or beams. Upon first LBT success on one of the BWPs on any one of the panels and/or beams, the UE starts transmitting a scheduled and/or configured UL burst without informing the gNB of the specific panel and/or beam used for UL transmission within the set. If the UE has an UL grant for multiple UL BWPs, the UE may transmit on a PUSCH and/or UL BWP for which LBT is successful. In such embodiments, the gNB may be ready to receive PUSCH on multiple BWPs. If LBT is not successful on a given BWP for a given panel and/or beam, then the UE switches to another BWP of the same panel and/or beam (if any) and performs LBT on such BWP. If LBT is not successful using any of the BWPs of the same panel and/or beam, then the UE switches a remaining panel and/or beam and perform a similar procedure on the remaining panel and/or beam. This procedure may be performed until all panels and/or beams have had LBT performed, if needed.

In some embodiments, a UE performs LBT on a set of panels and/or beams (e.g., indicated by a gNB) in a time domain manner on a given BWP and followed by LBT using the same set of panels and/or beams, but on another activated BWP. First, the UE performs LBT in one active BWP with a certain panel and/or beam and if the LBT is successful on the active BWP with a certain panel and/or beam at a certain point of time, then no further LBT is done on any remaining BWPs for any remaining panels and/or beams within the set of panels and/or beams. Upon LBT success on any of the BWPs on any one of the panels and/or beams, the UE starts transmitting a scheduled and/or configured UL burst without informing the gNB about the specific panel and/or beam used for UL transmission within the set. In such embodiments, if the UE has an UL grant for multiple UL BPWs, the UE may transmit on the PUSCH and/or UL BWP for which LBT is successful. The gNB may be ready to receive PUSCH on multiple BWPs. If LBT is not successful on a given BWP for a given panel and/or beam, the UE may switch to another panel and/or beam of the same BWP (if any) and performs LBT on the panel and/or beam. If LBT is not successful using any of the panels and/or beams of a given BWP, then the UE switches to a remaining BWP and perform a similar procedure on the remaining BWP. This procedure may be performed until all BWPs have had LBT performed, if needed.

In certain embodiments, a UE performs LBT on a set of active panels and/or beams (e.g., indicated by a gNB by an uplink grant and/or previous configuration) at the same time (e.g., parallel LBT) and if the LBT is successful on at least one of the panels and/or beams, then the UE starts transmitting a scheduled and/or configured UL burst on at least one of the panels and/or beams corresponding to the one of the panels and/or beams with LBT success without informing the gNB about the specific panel and/or beam used for UL transmission within the set. If LBT is not successful on any of the panels and/or beams, then the UE considers the LBT as having failed.

In various embodiments, if a UE is capable of and/or configured for receiving on multiple panels and/or beams at the same time, but not capable of or not configured for transmitting on multiple panels and/or beams at the same time, then the UE performs LBT on multiple panels and/or beams at the same time and, if more than one panel has LBT success, then the UE transmits the UL burst on only one of the panels and/or beams having LBT success. The panel and/or beam may be selected based on a lowest energy detection and, if multiple panels have a lowest energy detection, then the panel and/or beam with a lowest ID may be used for transmission. In some embodiments, a UE may select out of beams and/or panels having successful LBT the panel and/or beam having a strongest corresponding DL reception beam.

In certain embodiments, if a UE is capable of and/or configured for receiving on multiple panels and/or beams at the same time, and the UE is also capable and/or configured for transmitting on multiple panels and/or beams at the same time, then the UE performs LBT on multiple panels and/or beams at the same time and, if more than one panel and/or beam has LBT success, then the UE transmits the UL burst on all the panels and/or beams having LBT success.

In various embodiments, multiple active BWPs for UL are configured. In such embodiments, if LBT fails on all panels and/or beams for a given active BWP, then a UE switches the BWP and performs LBT on the new BWP for all the panels and/or beams at the same time. Once the LBT is successful on a given BWP on at least one of the multiple panels and/or beams, then the UL transmission is performed on that BWP on at least one of the panels and/or beams corresponding to the BWP with LBT success.

In some embodiments, if a UE is not capable of beam correspondence, a set of panels and/or beams for UL transmission may be determined at a gNB based on SRS transmission on more than one SRS resource and/or SRS resource set. Based on SRS measurements at the gNB, the gNB selects a set of panels and/or beams and indicates the set of panels and/or beams to the UE. For performing LBT at the UE, the gNB indicates a set of CSI-RS and/or SSB resources. Pairs of UE panel and/or beams for LBT and a corresponding UE panel and/or beams for UL transmission may be determined based on the set of indicated CSI-RS and/or SSB resources and SRS resources, respectively.

In certain embodiments, a gNB sends a set of SRS resource IDs and/or CSI-RS and/or SSB resource IDs.

In various embodiments, a network configures a mapping table for which each index of a table indicates a combination of panel IDs (e.g., may be referenced to SRS and/or CSI-RS/SSB resource IDs) and the gNB indicates one index of the table to the UE via DCI or higher layer signaling.

In some embodiments, a panel ID may be associated with an SRS resource set ID and beams within a panel may be associated with SRS resource IDs within that SRS resource set ID. If a gNB indicates only an SRS resource set ID, then the UE may identify a corresponding panel ID and may assume that all beams with the SRS resource IDs within the indicated SRS resource set ID associated with the beams of corresponding panel may be used for UL transmission. Moreover, CSI-RS resource set IDs and CSI-RS resource IDs within the set may be used for associating all the beams within the set for LBT at the UE.

In certain embodiments, if a UE is capable of beam correspondence, then the UE uses the CSI-RS and/or SSB measurements to determine a set of beams and/or panels for UL LBT and/or UL transmission. In various embodiments, the UE indicates a determined set of beams and/or panels to a gNB via a CSI-RS and/or SSB measurement report. The indicated set of beams and/or panels may be the beams and/or panels determined to be suitable for LBT by the UE as well as for UL transmission because of beam correspondence at the UE.

In some embodiments, a panel ID can be associated with a CSI-RS and/or SSB resource set ID and beams within a panel may be associated with CSI-RS and/or SSB resource IDs within that CSI-RS/SSB resource set ID.

In various embodiments, if a gNB indicates COT sharing information to a UE, the UE may assume beam correspondence. If there is beam correspondence, the UE may use CSI-RS and/or SSB measurements to determine a set of beams and/or panels for UL LBT and/or UL transmission. In some embodiments, a UE indicates a determined set of beams and/or panels to a gNB via a CSI-RS and/or SSB measurement report. The indicated set of beams and/or panels may be the beams and/or panels considered as suitable for LBT by the UE and/or for UL transmission because of beam correspondence at the UE.

In certain embodiments, a gNB may indicate additional information to a gNB, such as a maximum allowed deviation from a boresight of a received beam and/or a minimum and maximum allowed beamwidth for LBT and/or UL transmission.

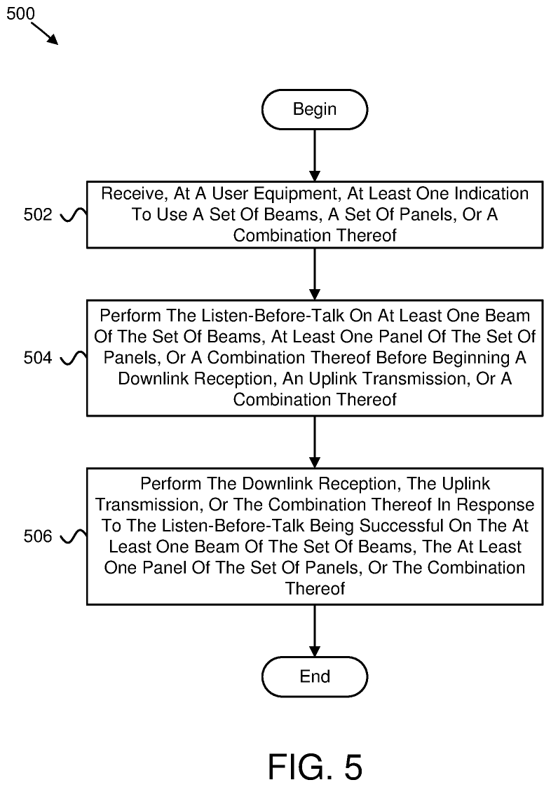

FIG. 5 is a flow chart diagram illustrating one embodiment of a method 500 for performing a listen-before-talk on beams and/or panels. In some embodiments, the method 500 is performed by an apparatus, such as the remote unit 102 and/or the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a user equipment, at least one indication to use a set of beams, a set of panels, or a combination thereof. In some embodiments, the method 500 includes performing 504 the listen-before-talk on at least one beam of the set of beams, at least one panel of the set of panels, or a combination thereof before beginning a downlink reception, an uplink transmission, or a combination thereof. In various embodiments, the method 500 includes performing 506 the downlink reception, the uplink transmission, or the combination thereof in response to the listen-before-talk being successful on the at least one beam of the set of beams, the at least one panel of the set of panels, or the combination thereof.

In certain embodiments, performing the listen-before-talk comprises performing the listen-before-talk on a first beam, and the downlink reception, the uplink transmission, or the combination thereof corresponding to the first beam is done on the first beam in response to the listen-before-talk being successful. In some embodiments, performing the listen-before-talk comprises performing the listen-before-talk on a second beam after performing the listen-before-talk on the first beam, and the downlink reception, the uplink transmission, or the combination thereof corresponding to the second beam is done on the second beam in response to the listen-before-talk being successful. In various embodiments, performing the listen-before-talk comprises performing the listen-before-talk on the set of beams, and the downlink reception, the uplink transmission, or the combination thereof corresponding to the set of beams is done on the set of beams in response to the listen-before-talk being successful.

In one embodiment, the at least one indication comprises: a set of downlink reference signal resources, a set of downlink resource set identifiers, or a combination thereof for determining the set of beams, the set of panels, or the combination thereof for performing the listen-before-talk; a set of uplink reference signal resources, a set of uplink resource set identifiers, or a combination thereof for determining the set of beams, the set of panels, or the combination thereof for performing uplink transmission on a sub-set of the set of beams, the set of panels, or the combination thereof after the listen-before-talk is successful; or some combination thereof. In certain embodiments, the at least one indication comprises: at least one downlink reference signal resource set identifier, wherein a listen-before-talk procedure is enabled to be performed on all beams of panels associated with the at least one downlink reference signal resource set identifier;

at least one uplink reference signal resource set identifier, wherein uplink transmission is enabled to be performed for an uplink transmission on a sub-set of the set of beams, the set of panels, or the combination thereof associated with the at least one uplink reference signal resource set identifier after the listen-before-talk is successful; or a combination thereof.

In some embodiments, the at least one indication comprises: at least one downlink resource identifier of a downlink reference signal resource set, wherein a listen-before-talk procedure is enabled to be performed on beams of a panel associated with the at least one downlink resource identifier of the downlink reference signal resource set; at least one uplink reference signal resource identifier of an uplink reference signal resource set, wherein uplink transmission is enabled to be performed on a sub-set of the beams of the panel associated with the at least one uplink reference signal resource identifier of the uplink reference signal resource set; or a combination thereof. In various embodiments, the at least one indication comprises a downlink reference signal resource identifier, a downlink resource set identifier, an uplink reference signal resource identifier, an uplink resource set identifier, or some combination thereof in response to the user equipment being capable of beam correspondence, and the set of beams, the set of panels, or the combination thereof are associated with the downlink reference signal resource identifier, the downlink resource set identifier, the uplink reference signal resource identifier, the uplink resource set identifier, or some combination thereof.

In one embodiment, performing the listen-before-talk on the at least one beam of the set of beams, the at least one panel of the set of panels, or a combination thereof comprises performing the listen-before-talk on all beams of the set of beams, all panels of the set of panels, or a combination thereof, and the method further comprises selecting a sub-set of beams, a sub-set of panels, or a combination thereof for uplink transmission in response to the listen-before-talk being successful. In certain embodiments, the listen-before-talk is performed on all beams of the set of beams, all panels of the set of panels, or the combination thereof in a time domain manner.

In some embodiments, the listen-before-talk is performed on all beams of the set of beams, all panels of the set of panels, or the combination thereof concurrently. In various embodiments, the method 500 further comprises performing the uplink transmission using only one beam of the sub-set of beams, only one panel of the sub-set of panels, or a combination thereof in response to the listen-before-talk being successful. In one embodiment, the method 500 further comprises performing the uplink transmission using a plurality of beams of the sub-set of beams, a plurality of panels of the sub-set of panels, or a combination thereof in response to the listen-before-talk being successful.

In certain embodiments, the listen-before-talk is performed on a beam that comprises the set of beams, in an omni-directional manner, or a combination thereof, and the downlink reception, the uplink transmission, or the combination thereof corresponding to the set of beams is done on the set of beams in response to the listen-before-talk being successful. In some embodiments, the at least one indication comprises a set of multiple active uplink bandwidth parts for performing the listen-before-talk. In various embodiments, performing the listen-before-talk comprises performing the listen-before-talk on multiple bandwidth parts in a time-domain manner, and, in response to the listen-before-talk being successful on an active uplink bandwidth part of the multiple bandwidth parts, the method comprises performing the uplink transmission on the active uplink bandwidth part.

In one embodiment, a method comprises: receiving, at a user equipment, at least one indication to use a set of beams, a set of panels, or a combination thereof; performing the listen-before-talk on at least one beam of the set of beams, at least one panel of the set of panels, or a combination thereof before beginning a downlink reception, an uplink transmission, or a combination thereof; and performing the downlink reception, the uplink transmission, or the combination thereof in response to the listen-before-talk being successful on the at least one beam of the set of beams, the at least one panel of the set of panels, or the combination thereof.

In certain embodiments, performing the listen-before-talk comprises performing the listen-before-talk on a first beam, and the downlink reception, the uplink transmission, or the combination thereof corresponding to the first beam is done on the first beam in response to the listen-before-talk being successful.

In some embodiments, performing the listen-before-talk comprises performing the listen-before-talk on a second beam after performing the listen-before-talk on the first beam, and the downlink reception, the uplink transmission, or the combination thereof corresponding to the second beam is done on the second beam in response to the listen-before-talk being successful.

In various embodiments, performing the listen-before-talk comprises performing the listen-before-talk on the set of beams, and the downlink reception, the uplink transmission, or the combination thereof corresponding to the set of beams is done on the set of beams in response to the listen-before-talk being successful.

In one embodiment, the at least one indication comprises: a set of downlink reference signal resources, a set of downlink resource set identifiers, or a combination thereof for determining the set of beams, the set of panels, or the combination thereof for performing the listen-before-talk; a set of uplink reference signal resources, a set of uplink resource set identifiers, or a combination thereof for determining the set of beams, the set of panels, or the combination thereof for performing uplink transmission on a sub-set of the set of beams, the set of panels, or the combination thereof after the listen-before-talk is successful; or some combination thereof.

In certain embodiments, the at least one indication comprises: at least one downlink reference signal resource set identifier, wherein a listen-before-talk procedure is enabled to be performed on all beams of panels associated with the at least one downlink reference signal resource set identifier; at least one uplink reference signal resource set identifier, wherein uplink transmission is enabled to be performed for an uplink transmission on a sub-set of the set of beams, the set of panels, or the combination thereof associated with the at least one uplink reference signal resource set identifier after the listen-before-talk is successful; or a combination thereof.

In some embodiments, the at least one indication comprises: at least one downlink resource identifier of a downlink reference signal resource set, wherein a listen-before-talk procedure is enabled to be performed on beams of a panel associated with the at least one downlink resource identifier of the downlink reference signal resource set; at least one uplink reference signal resource identifier of an uplink reference signal resource set, wherein uplink transmission is enabled to be performed on a sub-set of the beams of the panel associated with the at least one uplink reference signal resource identifier of the uplink reference signal resource set; or a combination thereof.

In various embodiments, the at least one indication comprises a downlink reference signal resource identifier, a downlink resource set identifier, an uplink reference signal resource identifier, an uplink resource set identifier, or some combination thereof in response to the user equipment being capable of beam correspondence, and the set of beams, the set of panels, or the combination thereof are associated with the downlink reference signal resource identifier, the downlink resource set identifier, the uplink reference signal resource identifier, the uplink resource set identifier, or some combination thereof.

In one embodiment, performing the listen-before-talk on the at least one beam of the set of beams, the at least one panel of the set of panels, or a combination thereof comprises performing the listen-before-talk on all beams of the set of beams, all panels of the set of panels, or a combination thereof, and the method further comprises selecting a sub-set of beams, a sub-set of panels, or a combination thereof for uplink transmission in response to the listen-before-talk being successful.

In certain embodiments, the listen-before-talk is performed on all beams of the set of beams, all panels of the set of panels, or the combination thereof in a time domain manner.

In some embodiments, the listen-before-talk is performed on all beams of the set of beams, all panels of the set of panels, or the combination thereof concurrently.

In various embodiments, the method further comprises performing the uplink transmission using only one beam of the sub-set of beams, only one panel of the sub-set of panels, or a combination thereof in response to the listen-before-talk being successful.

In one embodiment, the method further comprises performing the uplink transmission using a plurality of beams of the sub-set of beams, a plurality of panels of the sub-set of panels, or a combination thereof in response to the listen-before-talk being successful.

In certain embodiments, the listen-before-talk is performed on a beam that comprises the set of beams, in an omni-directional manner, or a combination thereof, and the downlink reception, the uplink transmission, or the combination thereof corresponding to the set of beams is done on the set of beams in response to the listen-before-talk being successful.

In some embodiments, the at least one indication comprises a set of multiple active uplink bandwidth parts for performing the listen-before-talk.

In various embodiments, performing the listen-before-talk comprises performing the listen-before-talk on multiple bandwidth parts in a time-domain manner, and, in response to the listen-before-talk being successful on an active uplink bandwidth part of the multiple bandwidth parts, the method comprises performing the uplink transmission on the active uplink bandwidth part.

In one embodiment, an apparatus comprises a user equipment. The apparatus further comprises: a receiver that receives at least one indication to use a set of beams, a set of panels, or a combination thereof; and a processor that: performs the listen-before-talk on at least one beam of the set of beams, at least one panel of the set of panels, or a combination thereof before beginning a downlink reception, an uplink transmission, or a combination thereof; and performs the downlink reception, the uplink transmission, or the combination thereof in response to the listen-before-talk being successful on the at least one beam of the set of beams, the at least one panel of the set of panels, or the combination thereof.

In certain embodiments, the processor performing the listen-before-talk comprises the processor performing the listen-before-talk on a first beam, and the downlink reception, the uplink transmission, or the combination thereof corresponding to the first beam is done on the first beam in response to the listen-before-talk being successful.

In some embodiments, the processor performing the listen-before-talk comprises the processor performing the listen-before-talk on a second beam after performing the listen-before-talk on the first beam, and the downlink reception, the uplink transmission, or the combination thereof corresponding to the second beam is done on the second beam in response to the listen-before-talk being successful.

In various embodiments, the processor performing the listen-before-talk comprises the processor performing the listen-before-talk on the set of beams, and the downlink reception, the uplink transmission, or the combination thereof corresponding to the set of beams is done on the set of beams in response to the listen-before-talk being successful.

In one embodiment, the at least one indication comprises: a set of downlink reference signal resources, a set of downlink resource set identifiers, or a combination thereof for determining the set of beams, the set of panels, or the combination thereof for performing the listen-before-talk; a set of uplink reference signal resources, a set of uplink resource set identifiers, or a combination thereof for determining the set of beams, the set of panels, or the combination thereof for performing uplink transmission on a sub-set of the set of beams, the set of panels, or the combination thereof after the listen-before-talk is successful; or some combination thereof.

In certain embodiments, the at least one indication comprises: at least one downlink reference signal resource set identifier, wherein a listen-before-talk procedure is enabled to be performed on all beams of panels associated with the at least one downlink reference signal resource set identifier; at least one uplink reference signal resource set identifier, wherein uplink transmission is enabled to be performed for an uplink transmission on a sub-set of the set of beams, the set of panels, or the combination thereof associated with the at least one uplink reference signal resource set identifier after the listen-before-talk is successful; or a combination thereof.

In some embodiments, the at least one indication comprises: at least one downlink resource identifier of a downlink reference signal resource set, wherein a listen-before-talk procedure is enabled to be performed on beams of a panel associated with the at least one downlink resource identifier of the downlink reference signal resource set; at least one uplink reference signal resource identifier of an uplink reference signal resource set, wherein uplink transmission is enabled to be performed on a sub-set of the beams of the panel associated with the at least one uplink reference signal resource identifier of the uplink reference signal resource set; or a combination thereof.

In various embodiments, the at least one indication comprises a downlink reference signal resource identifier, a downlink resource set identifier, an uplink reference signal resource identifier, an uplink resource set identifier, or some combination thereof in response to the user equipment being capable of beam correspondence, and the set of beams, the set of panels, or the combination thereof are associated with the downlink reference signal resource identifier, the downlink resource set identifier, the uplink reference signal resource identifier, the uplink resource set identifier, or some combination thereof.

In one embodiment, the processor performing the listen-before-talk on the at least one beam of the set of beams, the at least one panel of the set of panels, or a combination thereof comprises the processor performing the listen-before-talk on all beams of the set of beams, all panels of the set of panels, or a combination thereof, and the method further comprises selecting a sub-set of beams, a sub-set of panels, or a combination thereof for uplink transmission in response to the listen-before-talk being successful.

In certain embodiments, the listen-before-talk is performed on all beams of the set of beams, all panels of the set of panels, or the combination thereof in a time domain manner.

In some embodiments, the listen-before-talk is performed on all beams of the set of beams, all panels of the set of panels, or the combination thereof concurrently.

In various embodiments, the processor performs the uplink transmission using only one beam of the sub-set of beams, only one panel of the sub-set of panels, or a combination thereof in response to the listen-before-talk being successful.

In one embodiment, the processor performs the uplink transmission using a plurality of beams of the sub-set of beams, a plurality of panels of the sub-set of panels, or a combination thereof in response to the listen-before-talk being successful.

In certain embodiments, the listen-before-talk is performed on a beam that comprises the set of beams, in an omni-directional manner, or a combination thereof, and the downlink reception, the uplink transmission, or the combination thereof corresponding to the set of beams is done on the set of beams in response to the listen-before-talk being successful.

In some embodiments, the at least one indication comprises a set of multiple active uplink bandwidth parts for performing the listen-before-talk.

In various embodiments, the processor performing the listen-before-talk comprises the processor performing the listen-before-talk on multiple bandwidth parts in a time-domain manner, and, in response to the listen-before-talk being successful on an active uplink bandwidth part of the multiple bandwidth parts, the method comprises performing the uplink transmission on the active uplink bandwidth part.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving, at a user equipment, at least one indication to use a set of beams, a set of panels, or a combination thereof;
performing the listen-before-talk on at least one beam of the set of beams, at least one panel of the set of panels, or a combination thereof before beginning a downlink reception, an uplink transmission, or a combination thereof; and
performing the downlink reception, the uplink transmission, or the combination thereof in response to the listen-before-talk being successful on the at least one beam of the set of beams, the at least one panel of the set of panels, or the combination thereof.

2. The method of claim 1, wherein performing the listen-before-talk comprises performing the listen-before-talk on a first beam, and the downlink reception, the uplink transmission, or the combination thereof corresponding to the first beam is done on the first beam in response to the listen-before-talk being successful and performing the listen-before-talk on a second beam after performing the listen-before-talk on the first beam, and the downlink reception, the uplink transmission, or the combination thereof corresponding to the second beam is done on the second beam in response to the listen-before-talk being successful.

3. The method of claim 1, wherein performing the listen-before-talk comprises performing the listen-before-talk on the set of beams, and the downlink reception, the uplink transmission, or the combination thereof corresponding to the set of beams is done on the set of beams in response to the listen-before-talk being successful.

4. The method of claim 1, wherein the at least one indication comprises:
a set of downlink reference signal resources, a set of downlink resource set identifiers, or a combination thereof for determining the set of beams, the set of panels, or the combination thereof for performing the listen-before-talk;
a set of uplink reference signal resources, a set of uplink resource set identifiers, or a combination thereof for determining the set of beams, the set of panels, or the combination thereof for performing uplink transmission on a sub-set of the set of beams, the set of panels, or the combination thereof after the listen-before-talk is successful;
or some combination thereof.

5. The method of claim 1, wherein the at least one indication comprises a downlink reference signal resource identifier, a downlink resource set identifier, an uplink reference signal resource identifier, an uplink resource set identifier, or some combination thereof in response to the user equipment being capable of beam correspondence, and the set of beams, the set of panels, or the combination thereof are associated with the downlink reference signal resource identifier, the downlink resource set identifier, the uplink reference signal resource identifier, the uplink resource set identifier, or some combination thereof.

6. The method of claim 1, wherein performing the listen-before-talk on the at least one beam of the set of beams, the at least one panel of the set of panels, or a combination thereof comprises performing the listen-before-talk on all beams of the set of beams, all panels of the set of panels, or a combination thereof, and the method further comprises selecting a sub-set of beams, a sub-set of panels, or a combination thereof for uplink transmission in response to the listen-before-talk being successful.

7. The method of claim 6, wherein the listen-before-talk is performed on all beams of the set of beams, all panels of the set of panels, or the combination thereof in a time domain manner.

8. The method of claim 6, wherein the listen-before-talk is performed on all beams of the set of beams, all panels of the set of panels, or the combination thereof concurrently.

9. The method of claim 6, further comprising performing the uplink transmission using only one beam of the sub-set of beams, only one panel of the sub-set of panels, or a combination thereof in response to the listen-before-talk being successful.

10. The method of claim 6, further comprising performing the uplink transmission using a plurality of beams of the sub-set of beams, a plurality of panels of the sub-set of panels, or a combination thereof in response to the listen-before-talk being successful.

11. An apparatus comprising a user equipment, the apparatus comprising:
a receiver that receives at least one indication to use a set of beams, a set of panels, or a combination thereof; and
a processor that:
performs the listen-before-talk on at least one beam of the set of beams, at least one panel of the set of panels, or a combination thereof before beginning a downlink reception, an uplink transmission, or a combination thereof; and
performs the downlink reception, the uplink transmission, or the combination thereof in response to the listen-before-talk being successful on the at least one beam of the set of beams, the at least one panel of the set of panels, or the combination thereof.

12. The apparatus of claim 11, wherein the processor performing the listen-before-talk comprises the processor performing the listen-before-talk on a first beam, and the downlink reception, the uplink transmission, or the combination thereof corresponding to the first beam is done on the first beam in response to the listen-before-talk being successful and the processor performing the listen-before-talk on a second beam after performing the listen-before-talk on the first beam, and the downlink reception, the uplink transmission, or the combination thereof corresponding to the second beam is done on the second beam in response to the listen-before-talk being successful.

13. The apparatus of claim 11, wherein the processor performing the listen-before-talk comprises the processor performing the listen-before-talk on the set of beams, and the downlink reception, the uplink transmission, or the combination thereof corresponding to the set of beams is done on the set of beams in response to the listen-before-talk being successful.

14. The apparatus of claim 11, wherein the at least one indication comprises:
a set of downlink reference signal resources, a set of downlink resource set identifiers, or a combination thereof for determining the set of beams, the set of panels, or the combination thereof for performing the listen-before-talk;
a set of uplink reference signal resources, a set of uplink resource set identifiers, or a combination thereof for determining the set of beams, the set of panels, or the combination thereof for performing uplink transmission on a sub-set of the set of beams, the set of panels, or the combination thereof after the listen-before-talk is successful;
or some combination thereof.

15. The apparatus of claim 11, wherein the at least one indication comprises a downlink reference signal resource identifier, a downlink resource set identifier, an uplink reference signal resource identifier, an uplink resource set identifier, or some combination thereof in response to the user equipment being capable of beam correspondence, and the set of beams, the set of panels, or the combination thereof are associated with the downlink reference signal resource identifier, the downlink resource set identifier, the uplink reference signal resource identifier, the uplink resource set identifier, or some combination thereof.

16. The apparatus of claim 11, wherein the processor performing the listen-before-talk on the at least one beam of the set of beams, the at least one panel of the set of panels, or a combination thereof comprises the processor performing the listen-before-talk on all is beams of the set of beams, all panels of the set of panels, or a combination thereof, and the method further comprises selecting a sub-set of beams, a sub-set of panels, or a combination thereof for uplink transmission in response to the listen-before-talk being successful.

17. The apparatus of claim 16, wherein the listen-before-talk is performed on all beams of the set of beams, all panels of the set of panels, or the combination thereof in a time domain manner.

18. The apparatus of claim 16, wherein the listen-before-talk is performed on all beams of the set of beams, all panels of the set of panels, or the combination thereof concurrently.

19. The apparatus of claim 16, wherein the processor performs the uplink transmission using only one beam of the sub-set of beams, only one panel of the sub-set of panels, or a combination thereof in response to the listen-before-talk being successful.

20. The apparatus of claim 16, wherein the processor performs the uplink transmission using a plurality of beams of the sub-set of beams, a plurality of panels of the sub-set of panels, or a combination thereof in response to the listen-before-talk being successful.
